(19) United States
(12) Patent Application Publication
(10) Pub. No.: US 2014/0013440 A1
(43) Pub. Date: Jan. 9, 2014

(54) USER LICENSE CALCULATION IN A SUBSCRIPTION BASED LICENSING SYSTEM

(71) Applicants: Damandeep Thakur, Bangalore (IN); Horst Schaude, Kraichtal (DE); Santosh Nagaraja, Bangalore (IN)

(72) Inventors: Damandeep Thakur, Bangalore (IN); Horst Schaude, Kraichtal (DE); Santosh Nagaraja, Bangalore (IN)

(73) Assignee: SAP AG, Walldorf (DE)

(21) Appl. No.: 13/542,467

(22) Filed: Jul. 5, 2012

(51) Int. Cl. G06F 21/24

(52) U.S. Cl. 726/27

(57) ABSTRACT

Embodiments of the present invention may provide a method of calculating a user license for a software application. The method may include compiling, by a server, user interface components associated with a business role; generating a logical set for each compiled user interface component, the logical set including at least one license type required to access the user interface component; applying an intersection process on the logical sets to generate a result set including at least one result license type that can provide access to all the compiled user interface components, and assigning at least one result license type as the user license for the business role.

### FIELD OF THE INVENTION

The disclosure relates to a system and method for providing user license usage cost calculation in a subscription based licensing scheme.

### BACKGROUND

Business entities and government agencies depend more and more on software applications in daily operations. Traditionally, software applications have to be installed at the sites of the business entities and government agencies. With the development of the internet based cloud computing, computing becomes a service rather than a product such that shared resources, software, and information are provided to user work stations and other devices as a utility over a network (e.g., Internet). In this trend, software as a service, or software on-demand, provides a new business model for software customers to procure computing service, in which the software customers purchase licenses to subscribe to software services hosted by service providers (e.g., software vendors or application service providers).

In an on-demand solution, customers typically buy licenses from the service vendors.

A software application normally has different levels of functionalities and provides different license types for customers to choose. These licenses are priced according to the capabilities offered. A customer usually has to pay more for access to more functionalities and buy more number of licenses for a larger number of users. The business features requested by the customers can be available under different license schemes; however, currently there is no technique to calculate license assignments efficiently and cost effectively based on customer roles and/or business functions.

### BRIEF DESCRIPTION OF THE DRAWINGS

FIG. 1 illustrates a block diagram according to a system according to an embodiment of the present invention.

FIG. 2 illustrates a process for user interface association with license types according to an embodiment of the present invention.

FIG. 3 illustrates a process for license type assignment according to an embodiment of the present invention.

FIG. 4 illustrates an exemplary application according to an embodiment of the present invention.

FIG. 5 illustrates an exemplary application according to an embodiment of the present invention.

FIG. 6 illustrates a system implementation according to embodiment of the present invention.

FIG. 7 illustrates a computer structure according to an embodiment of the present invention.

### DETAILED DESCRIPTION

Embodiments of the present invention may provide a method of calculating a user license for a software application. The method may include compiling, by a server, user interface components associated with a business role; generating a logical set for each compiled user interface component, the logical set including at least one license type required to access the user interface component; applying an intersection process on the logical sets to generate a result set including at least one result license type that can provide access to all compiled user interface components, and assigning at least one result license type as the user license for the business role.

Embodiments of the present invention may provide a system including a database to store user interface components of a software application, wherein the database includes tags for each user interface components indicating at least one license type providing access to the user interface component. The system may also include a processor, communicatively coupled to the database, to generate a logical set of license types for each user interface component associated with a business role or function, to generate a result set by applying an intersection process to the logical sets, and to assign a license type for the business role or function based on the result set.

Embodiments of the present invention may provide a non-transitory medium to storing instructions adapted to be executed by a processor to perform a method. The method may include compiling user interface components associated with a business role; generating a logical set for each compiled user interface component, the logical set including at least one license type required to access the user interface component; applying an intersection process on the logical sets to generate a result set including at least one result license type that can provide access to all the compiled user interface components; and assigning at least one result license type as the user license for the business role.

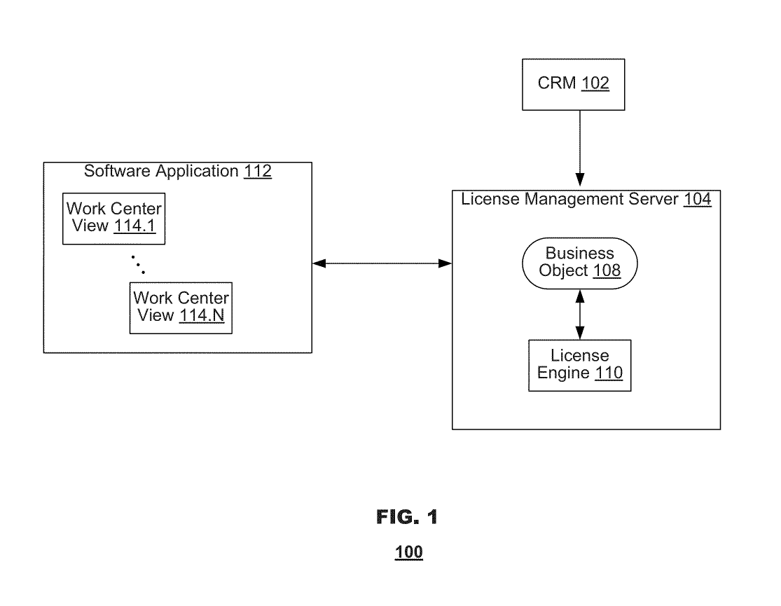

FIG. 1 illustrates a block diagram of a system 100 according to an embodiment of the present invention. The system 100 may include a customer relation management (CRM) system 102, a business software application 112, and a license management server 104. The CRM system 102 may be a license storage server that stores all orders for licenses. The license management server 104 may be a service provider management server that also functions as a license management server. The license management server 104 may include a license engine 110 and instantiate a business object 108 that uses the license engine 110 to perform license calculations. The business software application 112 may present business functionalities in a plurality of user interface (UI) components (e.g., work center views 114.1˜114.N, in which N may be an integer larger than one). These UI components may comprise the functionality the customer is using/accessing. In an embodiment, every work center view may be a user interface screen that is assigned to one or more tag type values representing a license type.

The license management server 104 may find and/or assign licenses as described below. The license management sever 104 may offer multiple types of licenses that vary with the complexity of business functionalities accessible. A license type may be designed for performing a certain set of business functions, and a business function may be covered by more than one license type. For example, the license management server may offer six license types, say license types 1, 2, 3, 4, 5, and 6. Each license type may be ranked according to the number and/or complexities of the business functionalities accessible by the license type. Moreover, the larger the number and/or more complex the business functionality, the pricier the license type may be. For example, license type 1 may offer basic functionalities of the software application 112 and, thus, may be the cheapest license. On the other hand, license type 6 in this example may offer the most and/or most complex business functionalities of the software application 112 and, thus may be the most expensive license.

The license management server 104 may store UI components or identifiers of the UI components in a database. The license management server 104 may also store license tags for each stored UI component in the database. The license tags, as discussed below in further detail, may include information as to which license type(s) provide access to the corresponding UI component.

Moreover, the customer, for example a business entity, may have different roles for its workforce to access the software application 112. The roles may correspond to work titles or positions inside the business entity. The customer may define any number of roles to access the software application 112. Each role's access of the software application 112 may be defined differently such that each role may access various portions of the software application 114. The various portions accessible by the different roles may be overlapping where different roles may have access to the same software application portion. For example, the customer may define roles based on work responsibilities such as Standard Self-Service User, Supply Chain Management (SCM) Enterprise User, Project Management Self-Service User, CRM Sales Team User, Standard Enterprise User, and SCM Enterprise User.

The software application 112 access may be modified and/or customized based on different customer roles. The license management server 104, in turn, may offer different license types for the different roles. The license types may correspond to UI components accessible by the particular license type.

In an embodiment, a customer may have an initial order of user licenses for the software application 112. After the initial order, the customer may also have additional order(s), renewal order(s), or both. Each order has a validity for a duration. Thus, the customer may need to prolong the validity of the initial order if the customer wants to us the software application 112 after the end of the validity of the initial order. This prolongation may be the renewal orders (with their own validities respectively). Furthermore, if the customer needs to adapt the license (e.g., buy additional licenses for users), the customer may do this with additional orders. Each order may contain information about what type of users and how many users per type are subscribed by the customer. Validity of each order may be updated and update of validity of the orders may also be sent to the license management server 104. In one or more embodiments, the complete information for each order may be sent to the license management server 104 instead of the changes (e.g., delta) of the respective order.

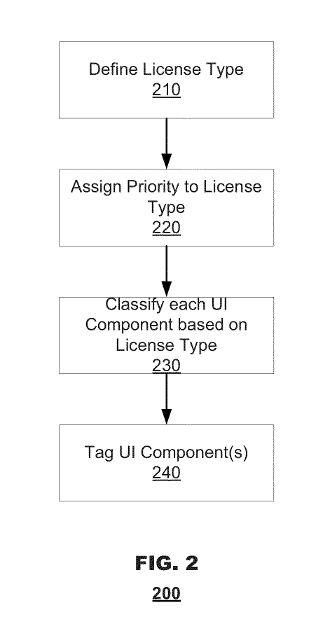

FIG. 2 illustrates a process 200 for associating UI components with different license type(s) according to an embodiment of the present invention. The process 200 may be performed by the license management server 104 in an embodiment. In step 210, license type(s) may be defined. In an embodiment, any number of license types may be defined. Each license type may offer different business functionalities as discussed above.

In step 220, a priority level may be assigned to each license type. In an embodiment, the priority may be based on price. For example, the cheapest license (say, license type 1) may be assigned the lowest priority while the most expensive license (say, license type 6) may be assigned the highest priority. Other criteria may be used for priority assignment.

In step 230, each UI component in the software application may be classified with respect to the defined license types. Based on the business functionality offered by the UI component, each UI component may be assigned to one or more license types. In an embodiment, every UI component may be assigned to the highest priority license type. In such an embodiment, the highest priority license type may include access to all UI components in the software application. Moreover, in an embodiment, if a UI component is not associated with any license types, for example a basic UI may be offered for free, that UI component may not be assigned to any license type.

In step 240, license tags may be generated in accordance with the UI component license type classifications. The license tags may be attached to the UI component (e.g., data structure). In an embodiment, a UI component may have a distinct license tag for each license type that the UI component is associated with. For example, if the UI component is associated with license types 1, 2, and 6, then the UI component may include three license tags for license types 1, 2, and 6 respectively. In another embodiment, a UI component may have one comprehensive license tag that includes information about each license type associated with the UI component. For example, if the UI component is associated with license types 1, 2, and 6, then the UI component may include one license tag relating information about its association with license types 1, 2, and 6.

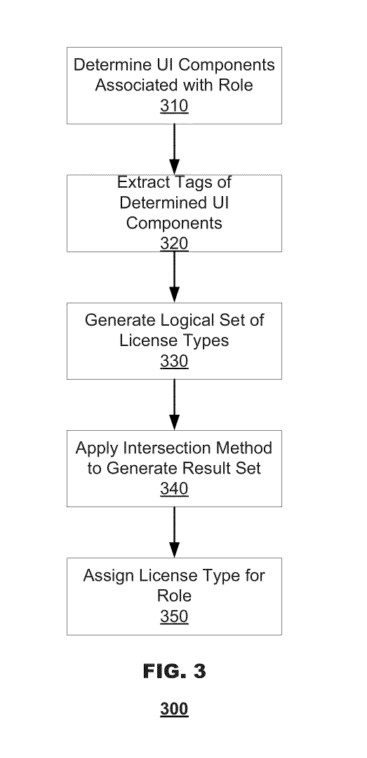

After the UI components are associated with the offered license types, the license types may assigned to different business roles and/or to different business functions. FIG. 3 illustrates a process 300 for assigning license types according to an embodiment of the present invention. The process 300 may be performed for each business role and/or for various business functions desired by the customer.

In step 310, all UI components associated with the role may be compiled. The compiled UI components may refer to all UI components used by the particular role. For example, if the role is a SCM enterprise user, the compiled UI components may refer to the supply chain UI components that a SCM enterprise user will use to perform his work duties.

In step 320, the license tags of the compiled UI components may be extracted. The license tags may be attached or integrated with the data structure of the UI components. The license tags may include information relating to the license types associated with the UI component. Hence, if the UI component is associated with multiple license types, the license tag(s) may identify all associated license types.

In step 330, a logical set may be generated for each compiled UI component and may indicate the license type(s) associated the respective UI component from the extracted license tags. The logical set may be a data string or the like.

In step 340, an intersection method may be applied to all generated logical sets to generate a result set. The intersection method may be an algorithm to calculate which common license(s) provide access to all compiled UI components. Thus, the intersection method may calculate which license(s) provide access to the business functionalities in the software application for the particular business role. The result set may contain one or more license types. In an embodiment where the highest priority license type provides access to all UI components offered in the software application, the result set may always include the highest priority license type. This all-inclusive license type may be the most expensive license type offered for that software application.

In step 350, a license type from the result set may be assigned to the role (or business function). If the result set contains more than one license type, a license type may be selected based on priority assignments. For example, in an embodiment, the lowest priority license type (e.g., cheapest license type) from the result may be selected. However, other criteria may be used to select the license type from the result set to assign to the particular role or business function.

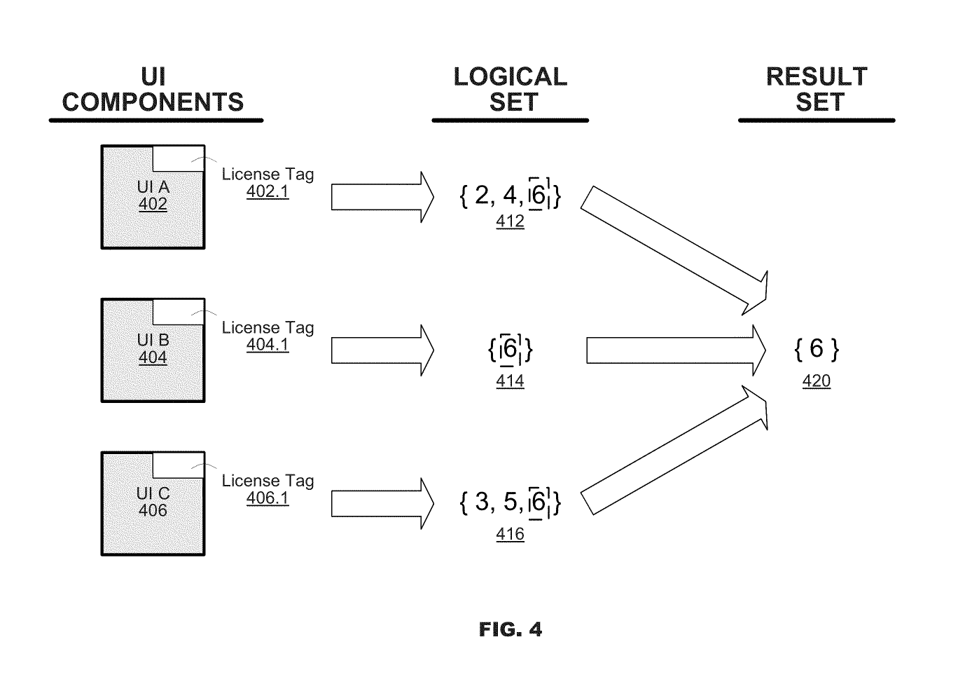

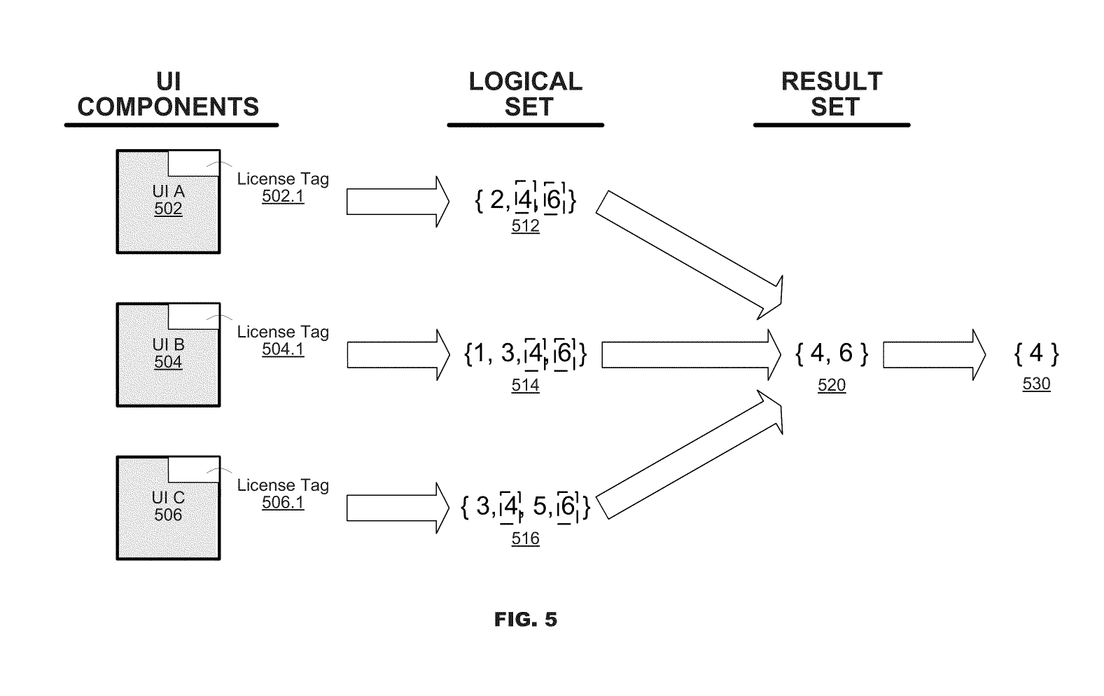

FIGS. 4 and 5 illustrate two exemplary applications of the license assignment processes described herein. In FIG. 4, three UI components may be identified for a particular role (or business function). The three UI components include UI A 402, UI B 404, UI C 406. Each UI component may include corresponding license tag(s) 402.1, 404.1, 404.3 that contain information about which license type(s) each UI component is associated therewith. The license type information may be extracted to generate logical sets 412, 414, and 416 each UI component respectively.

In the FIG. 4 example, logical set 412 may indicate that the UI component 402 may be accessible with license types 2, 4, or 6. Logical set 414 may indicate that UI component 404 may be accessible with license type 6 only. Logical set 416 may indicate that UI component 406 may be accessible with license types 3, 5, or 6. In this example, license type 6 may be the highest priority license type (e.g., most expensive) and, consequently, may be associated with all UI components.

An intersection method may be applied to logical sets 412, 414, and 416 to generate a result set 420. The result set may indicate which license type may provide access to all UI components 402, 404, and 406. In this example, the intersection method generates only one license type, which is license type 6, that can be used to access all UI components 402, 404, and 406 for the particular role. Thus, license type 6 may be assigned to that role.

Now, consider the example of FIG. 5. In FIG. 5, three UI components may be identified for a particular role (or business function). The three UI components include UI A 502, UI B 504, UI C 506. Each UI component may include corresponding license tag(s) 502.1, 504.1, 504.3 that contain information about which license type(s) each UI component is associated therewith. The license type information may be extracted to generate logical sets 512, 514, and 516 each UI component respectively.

In the FIG. 5 example, logical set 512 may indicate that the UI component 502 may be accessible with license types 2, 4, or 6. Logical set 514 may indicate that UI component 504 may be accessible with license type 1, 3, 4, or 6. Logical set 416 may indicate that UI component 406 may be accessible with license types 3, 4, 5, or 6. In this example, license type 6 may be highest priority license type (e.g., most expensive) and, consequently, may be associated with all UI components.

An intersection method may be applied to logical sets 512, 514, and 516 to generate a result set 520. The result set may indicate which license type may provide access to all UI components 502, 504, and 506. In this example, the intersection method generates a result set with two license types, 4 and 6, that can be used to access all the UI components identified for the particular role. Next, one license type from the result set may be selected to assign to the particular role as the assigned license type 530. The license type may be selected based on priority levels of the license types in the result set. In an embodiment, the license type with the lowest priority type (e.g., cheapest) may be selected. In the FIG. 5 example, license type 4 may be selected from the result set 520 as the assigned license 530.

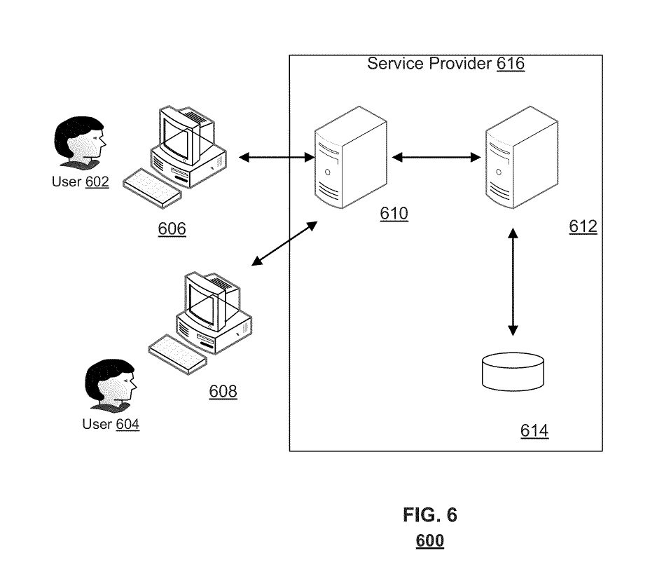

FIG. 6 illustrates a system 600 implementation according to an embodiment of the present invention. In the system 600, a business application may be hosted by a service provider 616 and installed on a server 610 maintained by the service provider 616. The service provider 616 may also maintain a license management server 612 and a database system 614. Users 602 and 604 may belong to a subscribed business customer of the service provider 616, and they may access the business application through their workstations 606 and 608 respectively. Each user 602 or 604 may be assigned to a respective business role according to customer's business needs. Thus, each user 602 and 604 may be given different access levels to functionalities provided by the business application. In one embodiment, access to the business application may provide via a network not controlled by either the customer or the service provider (e.g., the Internet).

The license management server 612 may host a licensing engine and business object as described herein. The database system 614 may be a storage for a CRM system as described herein. Thus, usage information for the business application may be collected at the server 610 and/or at the license management server 612. Also, the license management server 612 may store license subscription information. In an embodiment, the license subscription information may be associated with the defined business roles. In an embodiment, the service provider 616 may create additional roles, and the license management server 612 may calculate appropriate license types to associate with the additional roles based on the techniques described herein.

In an embodiment, each of the server 610, license management server 612, and database system 614 may be hosted separately by a respective physical server machine. In another embodiment, any two of them or all of them may be hosted by virtual machines running on one physical server machine.

In an embodiment, the service provider may host a software application for a plurality of customers with each customer being a tenant of the hosted software application. The license management server may be a central place for the service provider to manage the entire customer tenant related information. In a productive environment, the customer may have administrative staff that has authority to change a level of access of any software application users. On any such change, the usage of the software application may be calculated based on UI components assigned to users (more detail below). This usage information may be replicated from the software application to the license management server. The usage data may also have validity for a duration. If the usage assignment for a user is changed, the change may result in a change in license (e.g., stop using a license) and the validity is adjusted accordingly.

In an embodiment, a user for a particular customer may query, using the software application, for subscription relation information for a given validity. The query of the user may have a validity assigned to it (e.g., today, last month, last quarter). In response, a license calculation engine installed on the license management server may consider the license types, validity, usage and order data, and create a record for every month, valid as of a specific date. The license calculation engine may calculate the license usage based on existing licenses and their quantity bought by the particular customer.

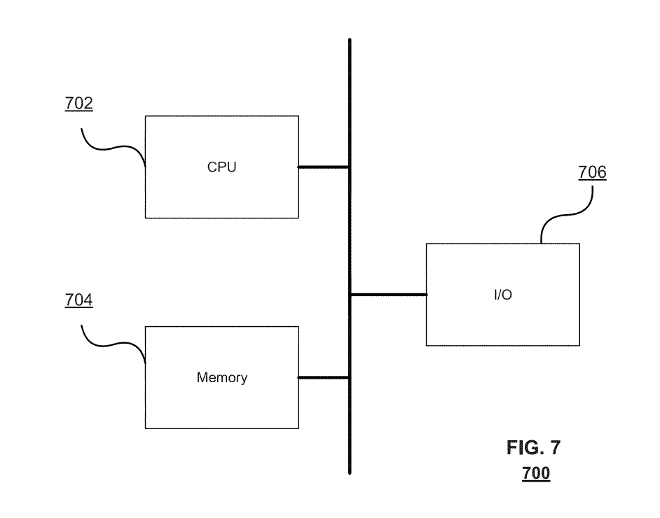

FIG. 7 illustrates a structure of a computer server 700 for license management according to an exemplary embodiment of the present invention. The computer server 700 may include a processor 702, a memory 704, and an I/O device(s) 706. The processor 702 may be coupled to the memory 704 and I/O device(s) 706. These connections may be direct or via other internal electronic circuitry or components.

The processor 702 may be a programmable processor that executes instructions residing in the memory 704 to receive and send data via the I/O device(s) 706. The instructions may perform the operations of the license verification described herein. The term programmable processor as used herein may be any programmable microprocessor or processor or combination of microprocessors or processors that can operate on digital data, which may be special or general purpose processors coupled to receive data and instructions from, and to transmit data and instructions to, a machine-readable medium.

Memory 704 is a machine-readable medium that stores data that may be processed by processor 702. The term machine-readable medium as used herein may be any addressable storage device that stores digital data including any computer program product, apparatus and/or device (e.g., a random access memory (RAM), read only memory (ROM), magnetic disc, optical disc, programmable logic device (PLD), tape, hard drives, RAID storage device, flash memory or any combination of these devices). This may include external machine-readable mediums that are connected to processor 402 via one or more I/O device(s) 706.

The I/O device(s) 706 may be one or more input/output interfaces that receive and/or send digital data to and from an external device. Interfaces as used herein are any point of access to an external device where digital data is received or sent, including ports, buffers, queues, subsets thereof, or any other interface to an external device.

It should be understood that there exist implementations of other variations and modifications of the invention and its various aspects, as may be readily apparent to those of ordinary skill in the art, and that the invention is not limited by specific embodiments described herein. Features and embodiments described above may be combined with and without each other. It is therefore contemplated to cover any and all modifications, variations, combinations or equivalents that fall within the scope of the basic underlying principals disclosed and claimed herein.

1. A method for calculating a user license for a software application, comprising:
compiling, by a server, user interface components associated with a business role;
generating a logical set for each compiled user interface component, the logical set including at least one license type required to access the user interface component;
applying an intersection process on the logical sets to generate a result set including at least one result license type that can provide access to all compiled user interface components; and
assigning at least one result license type as the user license for the business role.

2. The method of claim 1, further comprises tagging, by the server, user interface components in the software application with license tags, wherein the license tags include information of each license type providing access to the tagged user interface component.

3. The method of claim 2, further comprises extracting the license tags of compiled user interface components.

4. The method of claim 1, wherein multiple license types are prioritized.

5. The method of claim 4, wherein prioritization is based on license type cost.

6. The method of claim 4, wherein the result set includes more than one result license type and assigning is based on priority levels of the result license types.

7. A system, comprising:
a database to store user interface components and license tags associated with the user interface components; and
a processor, communicatively coupled to the database,
to generate a logical set of license types for each user interface component associated with a business role or function,
to generate a result set by applying an intersection process to the logical sets, and
to assign a license type for the business role or function based on the result set.

8. The system of claim 7, wherein the system is a computer server.

9. The system of claim 7, wherein the software application is distributed over multiple user terminals.

10. The system of claim 7, wherein multiple license types are prioritized.

11. The system of claim 10, wherein prioritization is based on license type cost.

12. The system of claim 10, wherein the result set includes more than one license type and the assignment is based on priority levels of the license types.

13. A non-transitory machine-readable medium storing instructions adapted to be executed by a processor to perform a method comprising:
compiling user interface components associated with a business role;
generating a logical set for each compiled user interface component, the logical set including at least one license type required to access the user interface component;
applying an intersection process on the logical sets to generate a result set including at least one result license type that can provide access to all compiled user interface components; and
assigning at least one result license type as the user license for the business role.

14. The non-transitory machine-readable medium of claim 13, wherein user interface components in the software application include a license tag, which includes information of each license type providing access to the tagged user interface component.

15. The non-transitory machine-readable medium of claim 14, wherein the license tags are extracted for the compiled user interface components.

16. The non-transitory machine-readable medium of claim of claim 13, wherein multiple license types are prioritized.

17. The non-transitory machine-readable medium of claim of claim 16, wherein prioritization is based on license type cost.

18. The non-transitory machine-readable medium of claim of claim 16, wherein the result set includes more than one result license type and assigning is based on priority levels of the result license types.
